(19) United States
(12) Patent Application Publication
(10) Pub. No.: US 2026/0258811 A1
(43) Pub. Date: Sep. 3, 2026

(54) IMPELLER FOR A COMPRESSOR, COMPRESSOR AND TURBOCHARGER

(71) Applicant: ACCELLERON SWITZERLAND LTD., Baden (CH)

(72) Inventor: Franco DOMENIG, Nussbaumen (CH)

(21) Appl. No.: 19/165,000

(22) PCT Filed: Feb. 20, 2024
(86) PCT No.: PCT/EP2024/054272

§ 371 Date: Sep. 12, 2025

(30) Foreign Application Priority Data
Mar. 24, 2023 (EP) 23164145.7

(51) Int. Cl. F04D 29/28; F02B 39/00; F04D 17/10

(52) U.S. Cl. CPC F04D 29/284; F02B 39/00; F04D 17/10

(57) ABSTRACT

An impeller for a radial or diagonal compressor is described. The impeller includes a plurality of main blades and a plurality of splitter blades. A main blade hub-side contour includes a first contour portion and a second contour portion wherein the following applies: 0.4≤(z_{IN SB}−z_{SB})/(z_{IN SB}−z_{OUT MB})≤0.5; 0.4≤(z_{IN MB}−z_{IN SB})/(z_{IN MB}−z_{OUT MB})≤0.7; ΔR₁/ΔR_{IN MB}≥0.9; ΔR₂/ΔR_{IN SB}≥0.9; and ΔR_{IN SB}/ΔR_{IN MB}≤0.8.

### TECHNICAL FIELD

Embodiments of the present disclosure relate to impellers for compressors, particularly radial or diagonal compressors, for instance for turbochargers. Further embodiments of the present disclosure relate to compressors, particularly radial or diagonal compressors, and turbochargers having such compressors.

### BACKGROUND

Exhaust turbochargers are nowadays used as standard for increasing the power of internal combustion engines, having a turbine in the exhaust tract of the internal combustion engine and having a compressor upstream of the internal combustion engine. Here, the exhaust gases of the internal combustion engine are expanded in the turbine. The work thus obtained is transferred by means of a shaft to the compressor, which compresses the air fed to the internal combustion engine. By using the energy of the exhaust gases to compress the air fed to the combustion process in the internal combustion engine, it is possible to optimize the combustion process and the efficiency of the internal combustion engine.

Compressors, in particular radial or diagonal compressors, with high-displacement compressor wheels have high ratios of the compressor wheel inlet radius R1 to the compressor wheel outlet radius R2, for example R1/R2>0.62. Typically, the flow is deflected in the radial direction in the impeller region or in the impeller and diffuser region, respectively, which leads to a large flow deflection and a large curvature of the shroud contour. Furthermore, high pressure ratios are typically also required, and therefore the compressor wheel hub design should preferably be designed to be slim in order to keep the centrifugal load below the mechanical material limits. A hub of slender design typically leads to a small exit angle of the compressor wheel hub contour (measured with respect to the radial).

There is an ongoing demand for compressor impellers which are improved in terms of mechanical high cycle fatigue behavior, particularly of the impeller blades, without influencing the impeller's volume flow rate. One of the main challenges is to provide compressor stages with high specific volume flow rates, for which the impeller throat area between neighboring impeller blades should be designed as large as possible.

Accordingly, in view of the above, there is a demand for an improved compressor impeller which at least partially overcome the problems of the state of the art.

### SUMMARY

In light of the above, an impeller for a radial or diagonal compressor according to independent claim 1 is provided. Further, a compressor including an impeller according to embodiments described herein as well as a turbocharger including such a compressor are provided. Further aspects, advantages, and features are apparent from the dependent claims, the description, and the accompanying drawings.

More specifically, according to an aspect of the present disclosure, an impeller for a radial or diagonal compressor is provided. The impeller includes a plurality of main blades having a main blade flow inlet edge, a main blade flow outlet edge, a main blade shroud-side contour and a main blade hub-side contour. Further, the impeller includes a plurality of splitter blades having a splitter blade flow inlet edge and a splitter blade flow outlet edge. The splitter blade flow inlet edge is arranged downstream from the main blade flow inlet edge. The main blade hub-side contour includes a first contour portion from an axial position z_{IN MB} of the main blade flow inlet edge at the main blade shroud-side contour to an axial position z_{IN SB} of the splitter blade flow inlet edge at the splitter blade shroud-side contour. Additionally, main blade hub-side contour includes a second contour portion from the axial position z_{IN SB} of the splitter blade flow inlet edge to an axial reference position z_{SB} of the splitter blades at the splitter blade shroud-side contour. The axial reference position z_{SB} is in the middle within a tolerance T of T≤10% between the axial position z_{IN SB} of the splitter blade flow inlet edge and an axial position z_{OUT MB} of the main blade flow outlet edge at the main blade shroud-side contour. The following conditions apply: a) 0.4≤(z_{IN SB}−z_{SB})/(z_{IN SB}−z_{OUT MB})≤0.5 and b) 0.4≤(z_{IN MB}−z_{IN SB})/(z_{IN MB}−z_{OUT MB})≤0.7. The axial direction of the axial coordinate z is opposite an inflow direction F of incoming fluid which is rotated by the impeller. The point of origin of the axial coordinate z is the last axial position of the main blade flow outlet edge in the inflow direction F. Further, for the first contour portion, upstream of a throat between neighboring main blades, a ratio of a radial distance ΔR₁ between the main blade hub-side contour and the main blade shroud-side contour to the radial extension ΔR_{IN MB} of the main blade flow inlet edge is ΔR₁/ΔR_{IN MB}≥0.9. Additionally, for the second contour portion upstream of the axial reference position z_{SB} a ratio of a radial distance ΔR₂ between the main blade hub-side contour and the main blade shroud-side contour to the radial extension ΔR_{IN SB} of the splitter blade flow inlet edge is ΔR₂/ΔR_{IN SB}≥0.9. Moreover, a ratio of the radial extension ΔR_{IN SB} of the splitter blade flow inlet edge to the radial extension ΔR_{IN MB} of the main blade flow inlet edge is ΔR_{IN SB}/ΔR_{IN MB}≤0.8.

Accordingly, compared to the state of the art, an improved impeller for a radial or diagonal compressor is provided. In particular, the impeller according to embodiments of the present disclosure beneficially provides for an improved design with which the impeller throat area can be maximized while at the same time blade stiffness of the impeller blades, particularly of the main blades, is improved.

According to another aspect of the present disclosure, a compressor, particularly a radial or diagonal compressor, including an impeller according to any embodiments described herein is provided.

According to further aspect of the present disclosure, a turbocharger, including a compressor according to any embodiments described herein is provided.

### BRIEF DESCRIPTION OF THE DRAWINGS

So that the manner in which the above recited features of the present disclosure can be understood in detail, a more particular description of the disclosure, briefly summarized above, may be had by reference to embodiments. The accompanying drawings relate to embodiments of the disclosure and are described in the following:

FIG. 1 shows a schematic cross-sectional view of an impeller according to embodiments described herein;

FIG. 2 shows a schematic perspective side view of a portion of an impeller according to embodiments described herein; and

FIG. 3 shows a schematic perspective front view of a portion of an impeller according to embodiments described herein.

### DETAILED DESCRIPTION OF EMBODIMENTS

Reference will now be made in detail to the various embodiments of the disclosure, one or more examples of which are illustrated in the figures. Within the following description of the drawings, the same reference numbers refer to same components. Generally, only the differences with respect to individual embodiments are described. Each example is provided by way of explanation of the disclosure and is not meant as a limitation of the disclosure. Further, features illustrated or described as part of one embodiment can be used on or in conjunction with other embodiments to yield yet a further embodiment. It is intended that the description includes such modifications and variations.

Within the following description of the drawings, the same reference numbers refer to the same or similar components. Generally, only the differences with respect to the individual embodiments are described. Unless specified otherwise, the description of a part or aspect in one applies to a corresponding part or aspect in another embodiment as well.

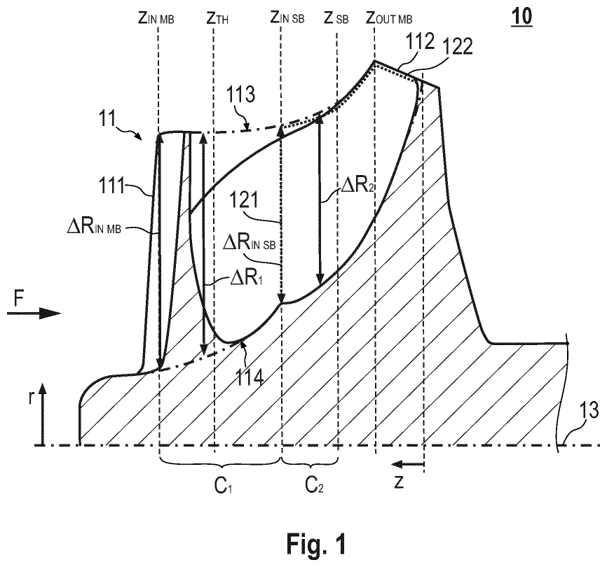

With reference to FIGS. 1 to 3, an impeller 10 for a radial or diagonal compressor according to embodiments of the present disclosure is described.

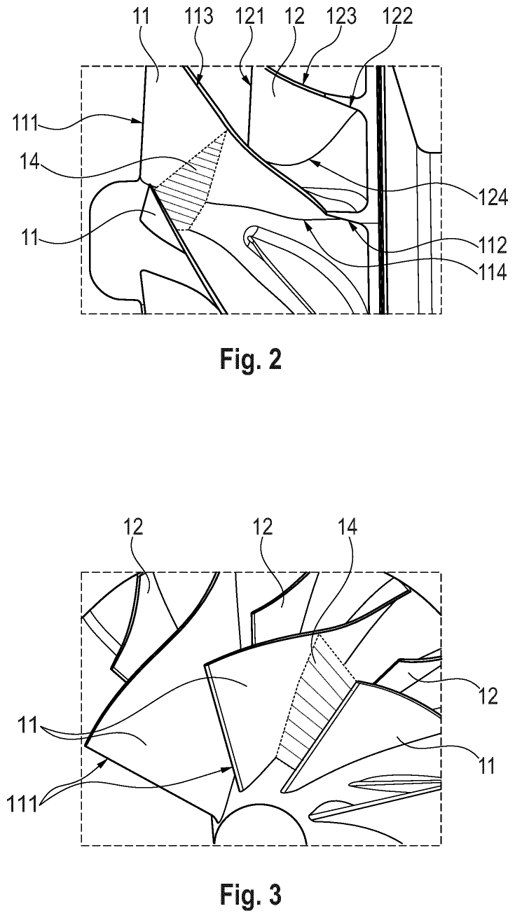

According to embodiments which can be combined with other embodiments described herein, the impeller 10 includes a plurality of main blades 11 having a main blade flow inlet edge 111, a main blade flow outlet edge 112, a main blade shroud-side contour 113 and a main blade hub-side contour 114. Further, the impeller 10 includes a plurality of splitter blades 12 having a splitter blade flow inlet edge 121 and a splitter blade flow outlet edge 122. The splitter blade flow inlet edge 121 is arranged downstream from the main blade flow inlet edge 111. Typically, the main blades 11 and the splitter blades 12 are arranged circumferentially in an alternating manner around a central rotation axis 13 of the impeller, as exemplarily shown in FIGS. 2 and 3.

Typically, the main blades of the impeller are curved blades and are attached to the central hub of the impeller. Splitter blades are typically located between the main blades of the impeller. It is to be understood, that during operation, the impeller rotates and compresses fluid, e.g. air or gas, passing through the compressor. The main blades are typically designed with a specific angle and shape to efficiently accelerate and compress the fluid, increasing its pressure and density. The main purpose of splitter blades is to guide and direct the fluid flow through the impeller blades, which improves the performance and efficiency of the compressor. In particular, splitter blades work by dividing the incoming fluid into smaller streams, which helps to reduce turbulence and improve the stability of the compressor.

In the present disclosure, the “main blade flow inlet edge” can be understood as the leading edge of the main blade where the airflow first enters the main blade, i.e. the edge of the main blade that faces the incoming fluid flow in the compressor impeller. The inflow direction F is exemplarily indicated in FIG. 1. Further, the radial direction r and the axial coordinate z are indicated in FIG. 1.

Typically, the main blade flow inlet edge is designed to efficiently accelerate and direct the incoming fluid flow into the blade, providing the necessary energy to compress the fluid as it passes through the compressor. Typically, the main blade flow inlet edge is designed to minimize turbulence and separation of the airflow, which can cause energy losses and reduce the compressor's efficiency.

In the present disclosure, the “splitter blade flow inlet edge” can be understood as the leading edge of the splitter blade where the airflow first enters the splitter blade, i.e. the edge of the splitter blade that faces the incoming fluid flow in the compressor impeller. This edge is designed to ensure that the flow of gas or air is directed properly into the impeller blades, where it can be compressed and accelerated to create the desired pressure and flow rate.

In the present disclosure, the “main blade flow outlet edge” can be understood as the trailing edge of the main blade where the compressed fluid flow exits the main blade, i.e. the edge of the main blade that faces away from the incoming fluid flow in the compressor impeller. Typically, the main blade flow outlet edge is designed to efficiently release the compressed fluid and smoothly redirect it towards the next stage of the compressor or the outlet. Typically, the main blade flow outlet edge is designed to minimize turbulence and pressure losses as the compressed fluid leaves the blade, which can cause energy losses and reduce the compressor's efficiency.

In the present disclosure, the “splitter blade flow outlet edge” can be understood as the trailing edge of the splitter blade where the compressed fluid flow exits the splitter blade, i.e. the edge of the splitter blade that faces away from the incoming fluid flow in the compressor impeller.

In the present disclosure, the “main blade shroud-side contour” can be understood as the profile or shape of the outer edge, particularly the radial outer edge, of the main blade on the side that faces the shroud, which is the outer casing of the compressor. Typically, the main blade shroud side contour is designed to reduce the leakage of compressed fluid past the blades to improve the efficiency of the compressor.

In the present disclosure, the “main blade hub-side contour” can be understood as the profile or shape of the inner edge, particularly the radial inner edge, of the main blade on the side that faces the hub, which is the central part of the compressor impeller. Typically, the hub side contour is designed to optimize the airflow and reduce energy losses within the compressor. In particular, typically the hub side contour is designed for ensuring that the airflow remains smooth and uniform as it passes through the impeller blades.

In the present disclosure, the “splitter blade shroud-side contour” can be understood as the profile or shape of the outer edge, particularly the radial outer edge, of the splitter blade on the side that faces the shroud of the compressor. The “splitter blade hub-side contour” can be understood as the profile or shape of the inner edge, particularly the radial inner edge, of the splitter blade on the side that faces the hub of the compressor.

With exemplary reference to FIG. 1, the main blade hub-side contour 114 includes a first contour portion C1 from an axial position z_{IN MB} of the main blade flow inlet edge 111 at the main blade shroud-side contour 113 to an axial position z_{IN SB} of the splitter blade flow inlet edge 121 at the splitter blade shroud-side contour 123. Additionally, the main blade hub-side contour 114 includes a second contour portion C2 from the axial position z_{IN SB} of the splitter blade flow inlet edge 121 to an axial reference position z_{SB} of the splitter blades 12 at the splitter blade shroud-side contour 123. The axial reference position z_{SB} is in the middle within a tolerance T of T≤10% between the axial position z_{IN SB} of the splitter blade flow inlet edge 121 and an axial position z_{OUT MB} of the main blade flow outlet edge 112 at the main blade shroud-side contour 113. The following conditions apply:

$$a ) 0.4 \leq ( {z}_{IN SB} - {z}_{SB} ) / ( {z}_{IN SB} - {z}_{OUT MB} ) \leq 0.5 , and$$

$$b ) 0.4 \leq ( {z}_{IN MB} - {z}_{IN SB} ) / ( {z}_{IN MB} - {z}_{OUT MB} ) \leq 0.7 .$$

In particular, the condition b) may be 0.55≤(z_{IN MB}−z_{IN SB})/(z_{IN MB}−z_{OUT MB})≤0.65. The axial direction of the axial coordinate z is opposite an inflow direction F of incoming fluid for rotating the impeller. The point of origin of the axial coordinate z is the last axial position of the main blade flow outlet edge in the inflow direction F. For the first contour portion C1, upstream of a throat between neighboring main blades 11, a ratio of a radial distance ΔR₁ between the main blade hub-side contour 114 and the main blade shroud-side contour 113 to the radial extension ΔR_{IN MB} of the main blade flow inlet edge 111 is ΔR₁/ΔR_{IN MB}≥0.9. Typically, the throat between neighboring main blades 11 is defined by the smallest flow cross-section between neighboring main blades 11. In particular, it is to be understood that in the context of an impeller, the throat refers to the narrowest section of the impeller's flow path, where the fluid is accelerated to a high velocity. Accordingly, the term “throat between neighboring main blades” can be understood as the narrowest flow cross-section of the flow path between adjacent main blades on the impeller.

Additionally, as exemplarily shown in FIG. 1, for the second contour portion C2, upstream of the axial reference position z_{SB}, a ratio of a radial distance ΔR₂ between the main blade hub-side contour 114 and the main blade shroud-side contour 113 to the radial extension ΔR_{IN SB} of the splitter blade flow inlet edge 121 is ΔR₂/ΔR_{IN SB}≥0.9. Further, a ratio of the radial extension ΔR_{IN SB} of the splitter blade flow inlet edge 121 to the radial extension ΔR_{IN MB} of the main blade flow inlet edge 111 is ΔR_{IN SB}/ΔR_{IN MB}≤0.8.

Accordingly, compared to the state of the art, an improved impeller for a radial or diagonal compressor is provided. In particular, the impeller according to embodiments of the present disclosure beneficially provides for an improved design with which the impeller throat area can be maximized while at the same time blade stiffness of the impeller blades, particularly of the main blades, is improved.

According to embodiments which can be combined with other embodiments described herein, the main blade hub-side contour 114 within a combination of the first contour portion C1 and the second contour portion C2 includes at least one curvature change. Typically, the at least one curvature change includes a first curvature change from a positive curvature to a negative curvature and a second curvature change from the negative curvature to a further positive curvature.

In the present disclosure, a “curvature change” of a contour can be understood as the rate at which the curvature of the contour changes at a given point. In other words, it describes how quickly the direction of the contour's curvature is changing as you move along the contour. Mathematically, the curvature change can be calculated by taking the second derivative of the contour equation with respect to arc length.

In the present disclosure, a “positive curvature” of a contour can be understood as a situation in which the contour curves in a convex manner at a given point. Accordingly, a “negative curvature” of a contour can be understood as a situation in which the contour curves in a concave manner at a given point.

According to embodiments which can be combined with other embodiments described herein, the main blade hub-side contour 114 within a combination of the first contour portion C1 and the second contour portion C2 comprises a S-shape contour portion. In the present disclosure, a “S-shape contour portion” can be understood as a contour portion which consists of two convex curves joined together by a concave curve in the middle.

It is to be noted that the S-shaped impeller hub contour allows to increase the impeller throat area through the possibility of minimizing the radius of the hub contour between the leading edges of the main and splitter blade. Further, including an area with negative curvature can be beneficial to increase stiffness of the blades specifically downstream of the impeller throat area. Accordingly, the impeller hub contour may emerge into a S-shape put on top of the basic curve with a positive curvature.

Further, it is to be noted that the S-shaped hub contour typically has only a minor impact on the optimal gas compression along the flow channel because of the typically low rotational speed at the hub contour. Therefore, flow separation is much less critical compared to the sensitive blade tip region so that the effect on the compression performance is negligible.

According to embodiments which can be combined with other embodiments described herein, a position of the throat on the first contour portion C1 is the position where a plane providing the smallest flow cross-section between neighboring main blades 11 intersects with the main blade hub-side contour 114, particularly at a main blade suction side.

According to embodiments which can be combined with other embodiments described herein, the following condition applies: (z_{IN MB}−z_{TH})/(z_{IN MB}−z_{OUT SB})≥0.3, wherein z_{TH} is a position at the main blade hub-side contour 114 where a plane providing the smallest flow cross-section between neighboring main blades 11 intersects with the main blade hub-side contour 114, particularly at the suction side of the main blade.

In the present disclosure, the “suction side” of a main blade can be understood as side or surface of the main blade that faces the incoming fluid flow. The suction side of the main blade has the technical function of drawing the fluid into the impeller. The suction side is typically curved or contoured to optimize the flow of the fluid and minimize turbulence. In contrast, the “pressure side” of the main blade is the side or surface of the main blade that faces away from the incoming fluid flow and has the technical function of creating a pressure differential that drives the fluid out of the impeller. The pressure side is typically flatter and less contoured than the suction side.

Accordingly, in view of the above it is to be understood that embodiments described herein beneficially provide for improved compressor impellers which can be used in radial or diagonal compressors, for instance of turbochargers. Accordingly, according to a further aspect of the present invention a compressor, particularly a radial or diagonal compressor, including an impeller according to any embodiments described herein is provided. Another aspect of the present invention pertains to a turbocharger including such a compressor. Thus, the present invention beneficially provides for a compressor impeller, a compressor and a turbocharger which provide for high specific volume flow rates and are improved with respect to their mechanical life cycle fatigue behavior.

While the foregoing is directed to embodiments of the disclosure, other and further embodiments of the disclosure may be devised without departing from the basic scope thereof, and the scope thereof is determined by the claims that follow.

### REFERENCE NUMBERS

10 impeller
11 main blade
111 main blade flow inlet edge
112 main blade flow outlet edge
113 main blade shroud-side contour
114 main blade hub-side contour
12 splitter blade
121 splitter blade flow inlet edge
122 splitter blade flow outlet edge
123 splitter blade shroud-side contour
124 splitter blade hub-side contour
13 central rotation axis
14 throat
C1 first contour portion of main blade hub-side contour
C2 second contour portion of main blade hub-side contour
F inflow direction
z axial coordinate
r radial direction
z_{IN MB} axial position of the main blade flow inlet edge
z_{TH} axial position of throat between neighboring main blades
z_{IN SB} axial position of the splitter blade flow inlet edge
z_{OUT MB} axial position of the main blade flow outlet edge
ΔR_{IN MB} radial extension of the main blade flow inlet edge
ΔR_{IN SB} radial extension of the splitter blade flow inlet edge
ΔR₁ radial distance between the main blade hub-side contour and the main blade shroud-side contour in the first contour portion C1
ΔR₂ radial distance between the main blade hub-side contour and the main blade shroud-side contour in the second contour portion C2

1.-11. (canceled)

12. An impeller for a radial or diagonal compressor, comprising:
a plurality of main blades having a main blade flow inlet edge, a main blade flow outlet edge, a main blade shroud-side contour and a main blade hub-side contour,
a plurality of splitter blades having a splitter blade flow inlet edge, a splitter blade flow outlet edge, the splitter blade flow inlet edge is arranged downstream from the main blade flow inlet edge,
the main blade hub-side contour comprising:
a first contour portion from an axial position z_{IN MB} of the main blade flow inlet edge at the main blade shroud-side contour to an axial position z_{IN SB} of the splitter blade flow inlet edge at the splitter blade shroud-side contour, and
a second contour portion from the axial position z_{IN SB} of the splitter blade flow inlet edge to an axial reference position z_{SB} of the splitter blades at the splitter blade shroud-side contour, the axial reference position z_{SB} being in the middle within a tolerance T of T≤10% between the axial position z_{IN SB} of the splitter blade flow inlet edge and an axial position z_{OUT MB} of the main blade flow outlet edge at the main blade shroud-side contour, wherein the following applies:
$$a ) 0.4 \leq ( {z}_{IN SB} - {z}_{SB} ) / ( {z}_{IN SB} - {z}_{OUT MB} ) \leq 0.5 ,$$
$$b ) 0.4 \leq ( {z}_{IN MB} - {z}_{IN SB} ) / ( {z}_{IN MB} - {z}_{OUT MB} ) \leq 0.7 ,$$
wherein the axial direction of the axial coordinate z is opposite an inflow direction F of incoming fluid for rotating the impeller, and wherein the point of origin of the axial coordinate z is the last axial position of the main blade flow outlet edge in the inflow direction F,
wherein for the first contour portion, upstream of a throat between neighboring main blades, a ratio of a radial distance ΔR₁ between the main blade hub-side contour and the main blade shroud-side contour to the radial extension ΔR_{IN MB} of the main blade flow inlet edge is ΔR₁/AR_{IN MB}≥0.9, and
wherein for the second contour portion, upstream of the axial reference position z_{SB}, a ratio of a radial distance ΔR₂ between the main blade hub-side contour and the main blade shroud-side contour to the radial extension ΔR_{IN SB} of the splitter blade flow inlet edge is ΔR₂/ΔR_{IN SB}≥0.9, and wherein a ratio of the radial extension ΔR_{IN SB} of the splitter blade flow inlet edge to the radial extension ΔR_{IN MB} of the main blade flow inlet edge is ΔR_{IN SB}/ΔR_{IN MB}≤0.8.

13. The impeller of claim 12, wherein the following applies:
$$0.55 \leq ( {z}_{IN MB} - {z}_{IN SB} ) / ( {z}_{IN MB} - {z}_{OUT MB} ) \leq 0.6 5 .$$

14. The impeller of claim 12, wherein the main blade hub-side contour within a combination of the first contour portion and the second contour portion comprises at least one curvature change.

15. The impeller of claim 14, wherein the at least one curvature change comprises a first curvature change from a positive curvature to a negative curvature and a second curvature change from the negative curvature to a further positive curvature.

16. The impeller of claim 12, wherein the main blade hub-side contour within a combination of the first contour portion and the second contour portion comprises a S-shape contour portion.

17. The impeller of claim 12, wherein the main blades and the splitter blades are arranged circumferentially in an alternating manner around a central rotation axis of the impeller.

18. The impeller of claim 12, wherein the throat between neighboring main blades is defined by the smallest flow cross-section between neighboring main blades.

19. The impeller of claim 12, wherein a position of the throat on the first contour portion is the position where a plane providing the smallest flow cross-section between neighboring main blades intersects with the main blade hub-side contour.

20. The impeller of claim 12, wherein a position of the throat on the first contour portion is the position where a plane providing the smallest flow cross-section between neighboring main blades intersects with the main blade hub-side contour at a main blade suction side.

21. The impeller of claim 12, wherein the following applies: (z_{IN MB}−z_{TH})/(z_{IN MB}−z_{OUT SB})≥0.3, wherein z_{TH} is a position at the main blade hub-side contour where a plane providing the smallest flow cross-section between neighboring main blades intersects with the main blade hub-side contour.

22. The impeller of claim 12, wherein the following applies: (z_{IN MB}−z_{TH})/(z_{IN MB}−z_{OUT SB})≥0.3, wherein z_{TH} is a position at the main blade hub-side contour where a plane providing the smallest flow cross-section between neighboring main blades intersects with the main blade hub-side contour at a suction side of the main blade.

23. A compressor with an impeller, the impeller comprising:
a plurality of main blades having a main blade flow inlet edge, a main blade flow outlet edge, a main blade shroud-side contour and a main blade hub-side contour,
a plurality of splitter blades having a splitter blade flow inlet edge, a splitter blade flow outlet edge, the splitter blade flow inlet edge is arranged downstream from the main blade flow inlet edge,
the main blade hub-side contour comprising:
a first contour portion from an axial position z_{IN MB} of the main blade flow inlet edge at the main blade shroud-side contour to an axial position z_{IN SB} of the splitter blade flow inlet edge at the splitter blade shroud-side contour, and
a second contour portion from the axial position z_{IN SB} of the splitter blade flow inlet edge to an axial reference position zs of the splitter blades at the splitter blade shroud-side contour, the axial reference position z_{SB} being in the middle within a tolerance T of T≤10% between the axial position z_{IN SB} of the splitter blade flow inlet edge and an axial position z_{OUT MB} of the main blade flow outlet edge at the main blade shroud-side contour, wherein the following applies:
$$a ) 0.4 \leq ( {z}_{IN SB} - {z}_{SB} ) / ( {z}_{IN SB} - {z}_{OUT MB} ) \leq 0.5 ,$$
$$b ) 0.4 \leq ( {z}_{IN MB} - {z}_{IN SB} ) / ( {z}_{IN MB} - {z}_{OUT MB} ) \leq 0.7 ,$$
wherein the axial direction of the axial coordinate z is opposite an inflow direction F of incoming fluid for rotating the impeller, and wherein the point of origin of the axial coordinate z is the last axial position of the main blade flow outlet edge in the inflow direction F,
wherein for the first contour portion, upstream of a throat between neighboring main blades, a ratio of a radial distance ΔR₁ between the main blade hub-side contour and the main blade shroud-side contour to the radial extension ΔR_{IN MB} of the main blade flow inlet edge is ΔR₁/ΔR_{IN MB}≥0.9, and
wherein for the second contour portion, upstream of the axial reference position z_{SB}, a ratio of a radial distance ΔR₂ between the main blade hub-side contour and the main blade shroud-side contour to the radial extension ΔR_{IN SB} of the splitter blade flow inlet edge is ΔR₂/ΔR_{IN SB}≥0.9, and wherein a ratio of the radial extension ΔR_{IN SB} of the splitter blade flow inlet edge to the radial extension ΔR_{IN MB} of the main blade flow inlet edge is ΔR_{IN SB}/ΔR_{IN MB}≤0.8.

24. The compressor of claim 23, wherein the following applies:
$$0.55 \leq ( {z}_{IN MB} - {z}_{IN SB} ) / ( {z}_{IN MB} - {z}_{OUT MB} ) \leq 0.6 5 .$$

25. The compressor of claim 23, wherein the main blade hub-side contour within a combination of the first contour portion and the second contour portion comprises at least one curvature change.

26. The compressor of claim 25, wherein the at least one curvature change comprises a first curvature change from a positive curvature to a negative curvature and a second curvature change from the negative curvature to a further positive curvature.

27. The compressor of claim 23, wherein the main blade hub-side contour within a combination of the first contour portion and the second contour portion comprises a S-shape contour portion.

28. The compressor of claim 23, wherein the main blades and the splitter blades are arranged circumferentially in an alternating manner around a central rotation axis of the impeller.

29. The compressor of claim 23, wherein the throat between neighboring main blades is defined by the smallest flow cross-section between neighboring main blades.

30. The compressor of claim 23, wherein a position of the throat on the first contour portion is the position where a plane providing the smallest flow cross-section between neighboring main blades intersects with the main blade hub-side contour.

31. A turbocharger comprising a compressor according to claim 23.
